(19) United States
(12) Patent Application Publication
(10) Pub. No.: US 2024/0106081 A1
(43) Pub. Date: Mar. 28, 2024

(54) BUSBAR INTERCONNECT WITH COUPLING SECTIONS FOR PHYSICALLY COUPLING A PLURALITY OF BUSBAR INTERCONNECTS OF IDENTICAL TYPE

(71) Applicant: Röchling Automotive SE, Mannheim (DE)

(72) Inventors: Fabrizio Chini, Isera (IT); Werner Farina, Bolzano (IT); Mirco Bragagnolo, Galliera Veneta (IT); Jacopo Molinaroli, Salorno (IT)

(21) Appl. No.: 18/476,917

(22) Filed: Sep. 28, 2023

(30) Foreign Application Priority Data
Sep. 28, 2022 (DE) 102022124988.3

(51) Int. Cl. H01M 50/507; H01M 50/204; H01M 50/503

(52) U.S. Cl. CPC H01M 50/507; H01M 50/204; H01M 50/503; H01M 2220/20

(57) ABSTRACT

The present invention relates to a busbar interconnect for electrically conductively connecting battery cells, comprising a plurality of contact prongs, the contact prongs being embodied integrally with an electrically conductive web structure, a covering structure composed of electrically insulating material being arranged at at least one section of the web structure.

The invention provides for the busbar interconnect to have a first coupling region with at least one first coupling formation and a second coupling region with at least one second coupling formation, said second coupling region being arranged at a distance along a distance axis, the first coupling formation and the second coupling formation being embodied complementarily such that the second coupling formation is couplable to a first coupling formation, and such that the first coupling formation is couplable to a second coupling formation.

The present invention relates to a busbar interconnect for electrically conductively connecting battery cells, in particular for use in a motor vehicle. The busbar interconnect comprises a plurality of exposed contact prongs, each of which is embodied for cohesive connection to a contact formation of a battery cell, the contact prongs being embodied integrally with an electrically conductive web structure. The web structure electrically conductively connects the contact prongs, a covering structure composed of electrically insulating material being arranged at at least one section of the web structure.

Such a busbar interconnect is known from US 2016/0315304 A1. It is used very generally, just like the busbar connector of the present invention, to form a vehicle battery as a drive energy store of a motor vehicle that is also or only electrically driveable, by producing an electrical connection between individual battery cells.

The known busbar interconnect electrically connects individual battery cells in parallel, such that a busbar interconnect forms a battery cell pack composed of battery cells connected in parallel. Two known busbar interconnects electrically connect the battery cell packs respectively formed by them in series with one another. This gives rise to a vehicle battery having a desired terminal voltage and a desired charging capacity.

The known busbar interconnect has a fuse section embodied as a fusible link section having a considerably smaller cross-section, i.e. electrical conduction cross-section, than conduction sections of the busbar interconnect adjacent on both sides of the fusible link section. Since a vehicle battery has a large number of battery cells, each of which is electrically connected to further battery cells by means of a known busbar interconnect with a fusible link section arranged in between, and since the fusible link section is furthermore sensitive to mechanical loads on account of its smaller or small material cross-section, the fusible link section at the known busbar interconnect is potted in thermoplastic material by injection moulding for stabilization and protection of said fusible link section. The covering structure thus formed completely surrounds the fusible link section in order to protect it as well as possible against external influences and thus against undesirable premature and unintended destruction.

A further busbar interconnect is known from U.S. Pat. No. 9,876,212 B2.

In order to form the vehicle battery, the known busbar interconnects are potted in a battery carrier referred to as a “battery tray” in the cited documents.

It is an object of the present invention to provide a technical teaching which makes it possible to interconnect battery cells to form a vehicle battery as flexibly as possible and at the same time as reliably as possible and thus to configure vehicle batteries with varying size or/and charging capacity or/and terminal voltage.

Proceeding from the busbar interconnect mentioned in the introduction, the present invention achieves this object by virtue of the fact that the busbar interconnect has a first coupling region with at least one first coupling formation and has a second coupling region with at least one second coupling formation, said second coupling region being arranged at a distance from the first coupling region along a virtual distance axis, the first coupling formation and the second coupling formation being embodied complementarily such that the second coupling formation of the busbar interconnect is couplable to a first mating coupling formation of a first connection object different from the busbar interconnect in question, the first mating coupling formation corresponding to the first coupling formation in terms of its shape and its dimensions, and that the first coupling formation of the busbar interconnect is couplable to a second mating coupling formation of a second connection object different from the busbar interconnect in question, the second mating coupling formation corresponding to the second coupling formation in terms of its shape and its dimensions.

For the sake of simplicity, the busbar interconnect of the present invention is also referred to hereinafter just for short as “busbar connector”.

By virtue of the complementary embodiment of the first coupling formation and the second coupling formation, a first coupling formation of a first busbar connector can be physically coupled to a second coupling formation embodied at a second busbar connector. The coupling is preferably a positively locking coupling. The coupling is likewise preferably releasable as intended, i.e. without destruction of the busbar connector, in order to be able to correct an arrangement of battery cells relative to one another in terms of their spatial dimensions. This does not preclude the coupling being made non-releasable after its production and after a possible correction of the relative position of coupled busbar connectors during a subsequent assembly process by means of joining processes, for instance by means of adhesive bonding or potting. However, the coupling is intended initially preferably to be releasable directly after its production.

The abovementioned connection object can thus be a further busbar connector of identical type or, if necessary, can be an end-side end busbar interconnect embodied separately if no further busbar interconnect on the other side of the already connected busbar connector is intended to be connected to said end busbar interconnect. In this regard, a desired plurality of busbar interconnects of identical type can be coupled to one another successively in a progression direction. The connection structure thus preferably formed from busbar interconnects embodied as identical parts can be terminated by an end-side end busbar interconnect at its respective end-side regions in the progression direction.

The coupling regions or the coupling formations preferably allow a physical connection of adjacent busbar connectors independently of their electrical connection. Although there is no intention to preclude a coupling of first and second coupling formations to one another also forming an electrical connection between the busbar interconnects coupled by the coupling formations, this is not preferred. The electrical connections of a busbar interconnect to a battery cell are preferably formed cohesively, i.e. for instance by soldering or welding, in particular laser welding. Therefore, the electrical connections of a busbar interconnect are generally no longer releasable, whereas a coupling of the complementarily embodied first and second coupling formations to one another is intended preferably to be releasable at least during a time period of an assembly process for forming the connection structure in order to be able to correct a spatial arrangement of coupled busbar interconnects at least within limits.

By virtue of the described connectability of identically embodied busbar interconnects to one another by means of complementary coupling regions, the busbar interconnect can be used as a modular busbar interconnect, such that a vehicle battery can be constructed modularly using numerous busbar interconnects of identical type.

Preferably, the busbar interconnect is a planar component, i.e. it extends in two mutually orthogonal spatial directions with considerably larger dimensions than in a thickness direction orthogonal to the two spatial directions mentioned. This planar embodiment can be curved, even multiply curved, such that the thickness direction can have locally different orientations in space. Preferably, the positively locking coupling of a first and a second coupling formation to one another is effective along relative movement directions which lie in the areal extent of the busbar interconnects involved. This means that the positively locking coupling of the first and second coupling formations spatially at least restricts or/and completely inhibits a relative movement of the busbar interconnects or connection objects coupled thereby in movement directions along the areal extent of the busbar interconnects or connection objects involved. The extent of restriction through to complete inhibition can be of varying magnitude direction-dependently within the areal extent. The positively locking coupling is likewise preferably producible and releasable by way of a relative movement of the busbar interconnects involved preferably in a direction transversely, in particular orthogonally, with respect to their areal extent.

By way of example, the busbar interconnect can be imagined as being surrounded by a virtual enveloping parallelepiped, the height dimension of the enveloping parallelepiped firstly being dependent on the curvature of sections of the busbar interconnect and secondly being significantly smaller than the dimensions in each case in directions which are orthogonal both with respect to one another and with respect to the height dimension and which are preferably the length and width directions of the enveloping parallelepiped. Preferably, the larger dimension in terms of absolute value out of length dimension and width dimension is at least five times, preferably at least ten times, larger than the height dimension of the enveloping parallelepiped.

In order to produce a positively locking coupling between the first and second coupling formations as simply as possible, one formation from the first and second coupling formations can have a projection and the respective other formation from the first and second coupling formations can have a cutout. In order to enable the abovementioned production of a positively locking coupling by way of relative movement of the busbar interconnect with a connection object transversely or orthogonally with respect to the areal extent, the projection protrudes from the rest of the busbar interconnect preferably transversely, particularly preferably orthogonally, with respect to the areal extent and an opening area of the cutout, through which the projection leads when coupling is established, runs preferably longitudinally, particularly preferably parallel, with respect to the areal extent.

In case of doubt, the areal extent is an extent parallel to a plane spanned by the longitudinal direction and the width direction of the enveloping parallelepiped.

It is also conceivable for the busbar interconnect to be embodied as a, in particular modular, base element of a vehicle battery such that it is invariant relative to a rotation by 180° about an axis of rotation that is orthogonal to the areal extent. For such a case, in particular, provision can be made for each coupling formation from the first and second coupling formations to have at least one projection and at least one cutout. Preferably, each coupling formation from the first and second coupling formations in this case has exactly the same number of projections as cutouts.

Preferably, the busbar interconnect discussed here is not only able to be coupled in a positively locking manner to a connection object, i.e. for instance a further busbar interconnect of identical type or an end busbar interconnect outlined above, rather the busbar interconnect and the connection object in the state coupled in a positively locking manner can be moved relative to one another at least in the common areal extent of busbar interconnect and connection object relative to one another within the scope of a movement clearance provided by the coupling. In this case, the movement space is considerably smaller than the spatial extension of the busbar interconnect and preferably also of the connection object in the areal extent. As a result, at the busbar interconnect, it is possible to correct manufacturing tolerances which are manifested in the form of dimensions that vary from component to component. Independently of the dimensions of a plurality of busbar interconnects used to form a vehicle battery, which dimensions vary on account of manufacturing tolerances, it is thus possible to ensure that the vehicle battery formed by the coupling of a plurality of busbar interconnects fits into the battery housing provided for it. For this purpose, it is advantageous if the cutout has a clear width which has a larger dimension than the projection in at least one direction as a tolerance compensation direction. Consequently, on account of the larger dimension of the clear width of the cutout in comparison with the projection leading through it in the state coupled in a positively locking manner, there is a movement clearance in the tolerance compensation direction between projection and cutout and thus between first coupling formation and second coupling formation.

Since the progression direction along which a plurality of busbar interconnects are physically coupled to one another generally runs parallel to the virtual distance axis between the first and second coupling regions, it is preferred for the tolerance compensation direction to run along the virtual distance axis. Varying dimensions of busbar interconnects coupled to one another add up along the progression direction, such that the greatest need for corrective relative movements between a busbar interconnect and a connection object coupled thereto is in that direction in which a particularly large number of busbar interconnects and/or connection objects are coupled to one another in a positively locking manner one behind another.

Additionally or alternatively, the tolerance compensation direction can run orthogonally with respect to the virtual distance axis in order to enable a position correction of the busbar interconnect relative to the connection object coupled thereto including in a further direction that is linearly independent with respect to the virtual distance axis. A linear combination of a relative mobility in the direction of the virtual distance axis and orthogonally with respect thereto can likewise be possible. Preferably, the movement clearance is greater along the virtual distance axis than orthogonally thereto.

For a further compensation of dimension differences that exist on account of manufacturing tolerances manifested, the electrically conductive web structure can have at least one spring section which is deformable in a predetermined manner with lower force than sections of the electrically conductive web structure adjacent to the spring section on both sides of the spring section. By way of example, the electrically conductive web structure in the spring section can be embodied as a meandering structure with adjacent meandering branches that are movable relative to one another, while the electrically conductive web structure on the other side of the spring section can be embodied as a solid conductor strip with a width at least identical to that of the spring section. Preferably, the web structure has a local longitudinal direction along which the spring section is arranged between two conventional, in particular solid, sections of the web structure. The width direction then runs orthogonally with respect to the local longitudinal direction and orthogonally with respect to the local thickness direction of the web structure. Instead of by way of the embodiment of a meandering structure, the spring section can be embodied as structurally weakened in relation to the adjacent conventional sections in a different fashion, for instance by way of the embodiment of a comblike structure or by way of local slotting of the web structure in the spring section.

In order that the spring section can manifest its effect as well as possible, it is preferably not embedded in the covering structure, but rather omitted from the latter.

The electrically insulating material of the covering structure can be any electrically non-conductive material. In case of doubt, materials having a resistance of at least 10⁸ ohms, preferably of at least 10⁹ ohms, are definitely electrically insulating materials. Preferably, the material is designed to be brought to the shape of the covering structure by primary forming. The covering structure is furthermore preferably producible by moulding or injection moulding of the electrically insulating material, in particular by the material of the covering structure being injection-moulded on or/and around the web structure. The electrically insulating material is preferably a thermally curing plastic, in particular a thermoplastic.

The web structure is preferably formed from metal—aluminium or an aluminium alloy for reasons of weight. The web structure can be a component which is obtained from a metal sheet, for instance by cutting out or stamping out.

The electrical connection of the busbar interconnect to a plurality of battery cells, which are usually arranged in a common plane, can advantageously be facilitated by a plurality of the contact prongs being placed in a common arrangement plane. Preferably, the contact prongs are elastically deflectable orthogonally with respect to the common arrangement plane by means of manual force in order to be able to provide a secure bearing of the contact prongs against the respective battery cells under elastic prestress before the contact prongs are cohesively connected to the battery cells. The arrangement plane preferably runs parallel to the plane of the areal extent, i.e., in the case of an enveloping parallelepiped of the busbar interconnect, parallel to the plane spanned by the longitudinal direction and the width direction of the parallelepiped. Additionally or alternatively, the contact prongs can be plastically deflectable orthogonally with respect to the common arrangement plane, in particular by means of manual force, in order to be able to provide the secure bearing of the contact prongs against the respective battery cells under elastic prestress before the contact prongs are cohesively connected to the battery cells.

In the present application, the term “plane” does not denote an infinitely thin mathematical plane, but rather a technical plane of finite thickness.

Preferably, the tolerance compensation direction is oriented parallel to the arrangement plane since the arrangement plane extends beyond the individual busbar interconnect to further coupled busbar interconnects and the greatest need for spatial correction in the arrangement of the battery cells and the busbar interconnects connecting them will be expected to be in this plane.

In principle, it is conceivable for at least one first coupling formation from the at least one first coupling formation to be arranged or embodied at a conductor section leading directly to a contact prong, for instance at a section of the covering structure that is arranged at this conductor section, in particular is injection-moulded thereon or around it in a manner surrounding this conductor section in a circumferential direction. However, in order to ensure that the positively locking coupling of the first coupling formation to a mating coupling formation of a connection object that corresponds to the second coupling formation as far as possible does not disturb the electrical connection between a contact prong placed close to the first coupling formation and a battery cell, the at least one first coupling formation is preferably embodied at a first connection lug running along the arrangement plane. Preferably, this first connection lug comprises no electrically conductive material, in particular no material of the web structure, at least not in the region of the embodiment of the coupling formation. The same preferably applies, mutatis mutandis, to at least one second coupling formation of the at least one second coupling formation. Accordingly, the at least one second coupling formation is preferably embodied at a second connection lug running along the arrangement plane. The second connection lug, too, at least in the region of the embodiment of the coupling formation, preferably comprises no electrically conductive material, in particular no material of the web structure, and is thus preferably exclusively embodied for producing the mechanical coupling to a first mating coupling formation corresponding to the first coupling formation.

In order to ensure that the first and second connection lugs can be coupled to one another in a positively locking manner by means of their coupling formations, without this resulting in a change in the relative position of one of the busbar interconnects involved orthogonally with respect to the arrangement plane of the battery cells, the first connection lug and the second connection lug are preferably arranged offset relative to one another transversely with respect to the arrangement plane. The offset of the first and second connection lugs transversely with respect to the arrangement plane preferably corresponds to the thickness of one of the two connection lugs. Preferably, both connection lugs have the same thickness.

The first or/and the second connection lug is/are preferably formed exclusively by injection moulding, in line with the explanation above.

In principle, there is no intention to preclude at least one coupling formation from the first coupling formation or/and the second coupling formation being embodied by electrically conductive material of a conductor section of the web structure configured for electrical conduction. An advantageously unrestricted possibility for the physical configuration of a coupling formation can be obtained by virtue of at least one of the at least one first coupling formation or/and at least one of the at least one second coupling formation being embodied at the covering structure. Specifically, the covering structure is preferably formed by primary forming, particularly preferably by injection moulding.

The covering structure can be adhesively bonded to the electrically conductive web structure as a preformed component. Preferably, as already explained above, the covering structure is injection-moulded onto the electrically conductive web structure, i.e. it covers only one part of the web structure in the injection-moulded region, while another part is either bare and exposed or covered by a different structure from the injection-moulded covering structure. Alternatively or additionally, the covering structure can be injection-moulded around the electrically conductive web structure, such that the covering structure completely surrounds the web structure in a circumferential direction in a section that is injection-moulded around it. The covering structure can moreover be injection-moulded onto the web structure with omission of sections of the web structure in one region and can completely surround the web structure in another region.

If one or a plurality of battery cells connected to a web structure have a defect, an undesirably high current flow between the battery cells can occur via the web structure. In order to be able to prevent such an undesirably high current flow in a timely manner, the electrically conductive web structure, between two contact prongs, can have at least one fuse section embodied integrally with the web structure.

Preferably, the web structure has a smaller conduction cross-section in the fuse section than in the regions between the fuse section and each of the two contact prongs that are electrically connected with the involvement of the fuse section, such that the fuse section can serve as a fusible link section on account of its locally higher resistance.

Preferably, at least one part of the fuse section is exposed without being covered by the covering structure. This has a number of technical advantages: firstly, the fuse section is able to be checked visually, such that possible failure of battery cells is easily ascertainable locally. Secondly, this prevents an alteration of the fuse properties as a result of the fuse section being encapsulated by injection moulding, as is the case in the prior art. The thermoplastic material completely surrounding the fuse section in the prior art also thermally insulates the fuse section, such that depending on the injection-moulding encapsulation respectively formed, fuse sections may trigger differently despite identical electrical conditions. Thirdly, an exposed fuse section can be used for fixing the web structure in an injection mould for thermoplastic material to be injection moulded on or around it. The web structure can thus be held particularly securely in the cavity of the injection mould, even if the thermoplastic is injected into the cavity at high speed. As a consequence, it is thus possible to produce a high number of busbar interconnects of identical type with uniform quality and uniform properties.

As has already been explained above, the spring section, too, is preferably exposed without being covered by the covering structure, in order to be able to implement the desired elastic deformation owing to external forces acting.

The reduction of the cross-section of the conductor section of the web structure in the fuse section in order to form the fuse section can be realized structurally by virtue of the fact that the fuse section, in a conductor section of the web structure connecting the two contact prongs along a connection path, is formed by a constriction narrowing the conductor section orthogonally with respect to the connection path or/and by a passage opening leading through the conductor section. The narrowing constriction can be fixed by corresponding projections in the cavity of the injection mould which engage into the constriction, preferably engage complementarily according to the key-lock principle. Preferably, projections engage into the constriction from opposite sides, such that the fuse section with the reduced cross-sectional area compared with the rest of the conductor section is arranged between the projections in the injection mould.

Likewise, a projection or mandrel in the cavity of the injection mould can lead through the passage opening formed in the fuse section of the conductor section and can thereby fix the web structure in the injection mould. For effective fixing, the passage opening is preferably embodied non-rotationally symmetrically in relation to an axis leading through it. For this purpose, for example, an edge bounding the passage opening can be embodied as a polygon with rectilinear edge sections or/and with curved edge sections, the centre of curvature of which is placed at a distance from an axis imagined to be leading centrally through the passage opening orthogonally with respect to its opening area.

In the case of a collision of a vehicle which carries and uses a vehicle battery with at least one busbar interconnect formed in accordance with the above description, collision-dictated short circuits between battery cells within the vehicle battery should be avoided. Battery cells are often arranged in a structural template corresponding to their desired spatial arrangement. Within certain limits this prevents a displacement of the battery cells parallel to the areal extent of the busbar interconnects or to the arrangement plane mentioned above. However, the battery cells generally have their contactable contact formations or terminals both at one or one each at another of their two longitudinal ends. For undesired short circuits, deformations orthogonally with respect to the areal extent of the busbar interconnects or with respect to the arrangement plane mentioned above are therefore of particular significance since a plurality of longitudinal ends of battery cells can be unforeseeably contacted and short-circuited, for example, in an undesirable manner as a result of such a deformation.

In order to prevent such an undesired collision-dictated contacting, in accordance with one advantageous development of the present invention, at least one distance ensuring section can be embodied at the covering structure of the busbar interconnect, said at least one distance ensuring section, orthogonally with respect to the arrangement plane, having a larger height dimension than sections of the covering structure adjacent to the at least one distance ensuring section. By virtue of the greater height dimension, the distance ensuring section can form a physical barrier against the battery terminals being approached by structures, for example sections of a battery housing. Preferably, that dimension of the distance ensuring section which is referred to as height dimension, in a direction orthogonally with respect to the areal extent of the busbar interconnect or with respect to the arrangement plane mentioned above, is larger than the thickness of said section measured parallel to the areal extent or arrangement plane, which imparts to said section a particularly advantageous area moment of inertia against a bending deformation about a bending axis running parallel to the areal extent or arrangement plane.

The aforementioned distance ensuring section is a particularly advantageous embodiment of the busbar interconnect which, in order to increase collision protection of the busbar interconnect, can be realized directly as a development of the busbar interconnect mentioned in the introduction, without the busbar interconnect having the coupling regions mentioned. For such a busbar interconnect, too, the applicant reserves the right to claim independent protection. A plurality of the contact prongs are then placed in a common arrangement plane in relation to which the height dimension of the distance ensuring section runs orthogonally.

Developments of the above-described busbar interconnect which are not related directly to the contact regions are also developments of the busbar interconnect that is mentioned in the introduction and is embodied with the distance ensuring section mentioned.

Preferably, the distance ensuring section is a solid section which not only can be produced in a simple manner by injection moulding but can have a high component stiffness orthogonally with respect to the areal extent or arrangement plane, such that it can be deformed only by very high forces in a direction orthogonally with respect to the areal extent or arrangement plane.

Preferably, the at least one distance ensuring section is the region in which the busbar interconnect has the largest height dimension to be measured orthogonally with respect to the areal extent or with respect to the arrangement plane. In this case, the distance ensuring section, owing to its physical dimension, determines a minimum distance of an object approaching the battery cells orthogonally with respect to the areal extent or with respect to the arrangement plane.

Since precisely a contact formation of a battery cell is intended to be protected against undesired contacting by means of a distance ensuring section of the busbar interconnect, it is preferred for the at least one distance ensuring section to at least sectionally surround a contact prong of the busbar interconnect that is electrically connected to a coupling formation of a battery cell in the operational state of a vehicle battery.

Preferably, the contact prong is embodied as a longitudinal end of a conductor section of the web structure, such that the contact prong is embodied as a projecting longitudinal end of a conductor section, referred to hereinafter as “contact conductor section”, and is thus accessible for producing a cohesive connection to a battery terminal.

Preferably, the distance ensuring section only partly surrounds the contact prong, such that the distance ensuring section does not hinder a further contacting of the battery cell—already contacted by the contact prong—by another busbar interconnect. Both opposite electrical terminals or coupling formations of a battery cell are often embodied at the same longitudinal end of the battery cell, such that the same longitudinal end of the battery cell is only contacted by contact prongs of different busbar interconnects at different points. In general, two different busbar interconnects which contact different contact formations of a battery cell with their respective contact prongs are also physically connected to one another in a positively locking manner by the first and second coupling formations.

In order as far as possible not to hinder the contacting of one and the same battery cell by a further contact prong of a further busbar interconnect, the distance ensuring section is preferably interrupted in a region imagined to be lengthened along the course direction of the conductor section or/and in a region imagined to be lengthened along the virtual distance axis beyond the contact prong. By virtue of this interruption, if necessary, the contact prong of the further busbar interconnect can run towards the battery cell to be contacted.

The busbar interconnect can have a plurality of contact conductor sections running next to one another, a contact prong being embodied at at least one longitudinal end of a contact conductor section.

Preferably, the contact conductor sections run not only next to one another but parallel to one another, which considerably facilitates the arrangement of the battery cells to be contacted. Preferably, the contact conductor sections run, in particular rectilinearly, parallel to the virtual distance axis. A contact conductor section can furthermore preferably have a respective contact prong not only at one of its longitudinal ends, but preferably at each of its opposite longitudinal ends.

Contact conductor sections running directly next to one another can be electrically conductively connected to one another by a connection conductor section running between the contact conductor sections. In order to save material, the connection conductor section can be embodied with a smaller conduction cross-section than the contact conductor sections connected by it.

Preferably, the spring section is embodied in a contact conductor section.

The particularly close-packed arrangement of battery cells can be further assisted by the contact conductor sections being arranged offset with respect to one another along their course direction.

The present invention will be explained in greater detail below with reference to the accompanying drawings, in which:

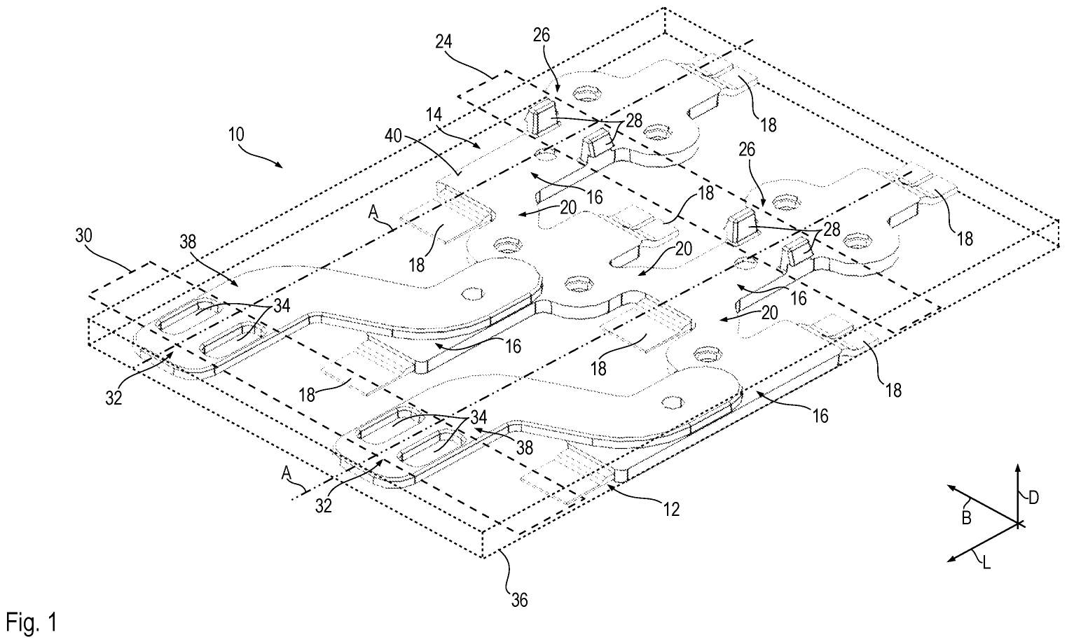

FIG. 1 illustrates a perspective view of a first embodiment according to the invention of a busbar interconnect of the present application,

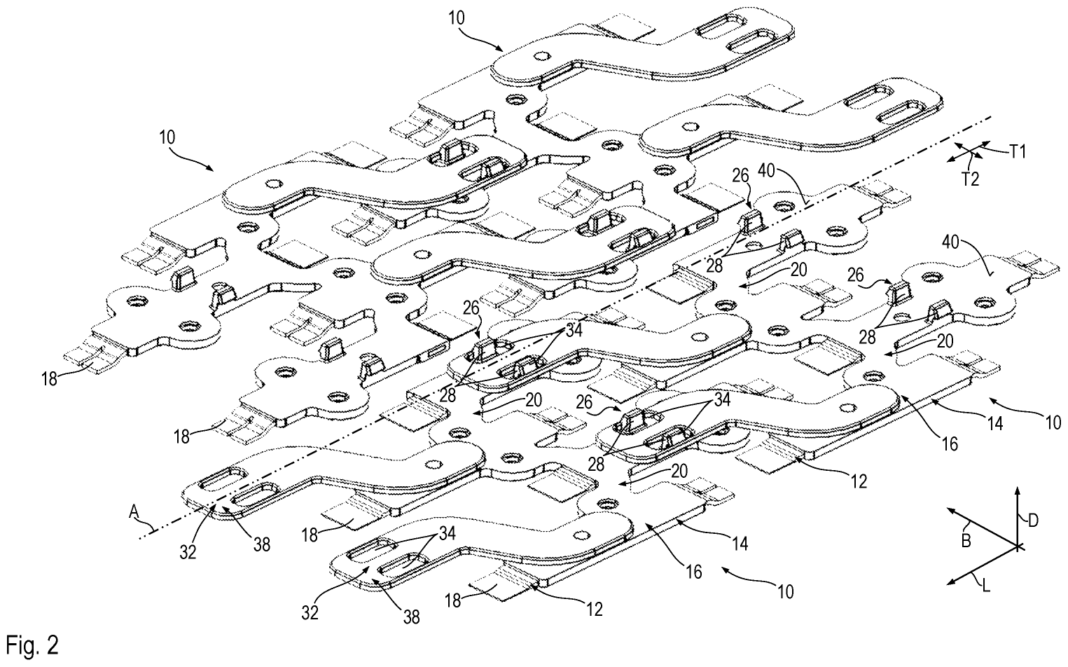

FIG. 2 shows a perspective view of a plurality of busbar interconnects of the first embodiment from FIG. 1 that are coupled to one another,

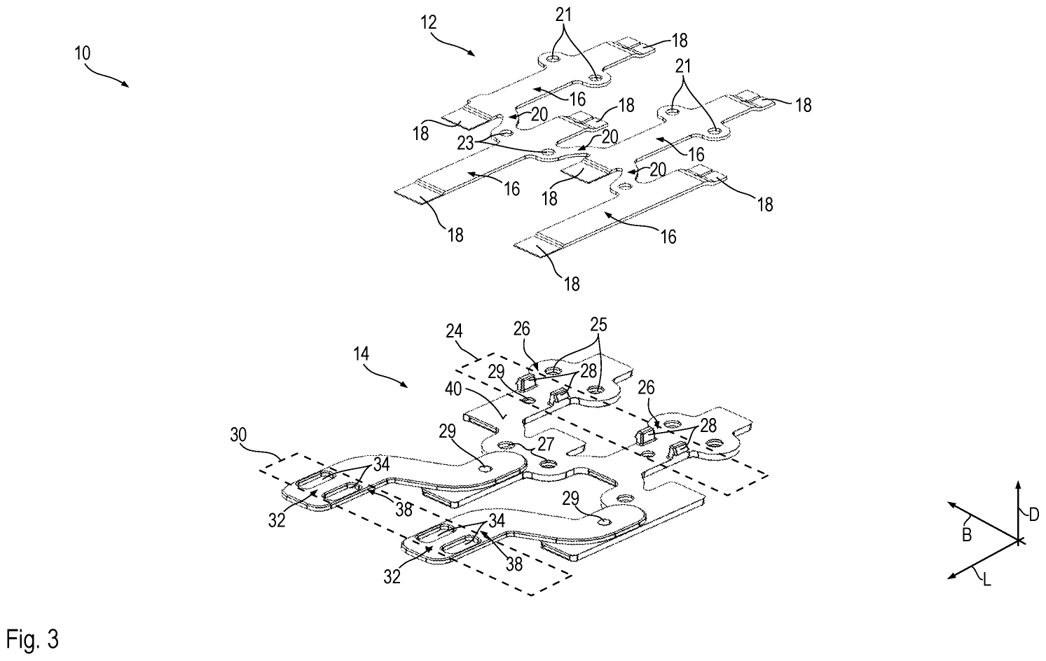

FIG. 3 shows a perspective exploded view of the busbar interconnect of the first embodiment from FIG. 1,

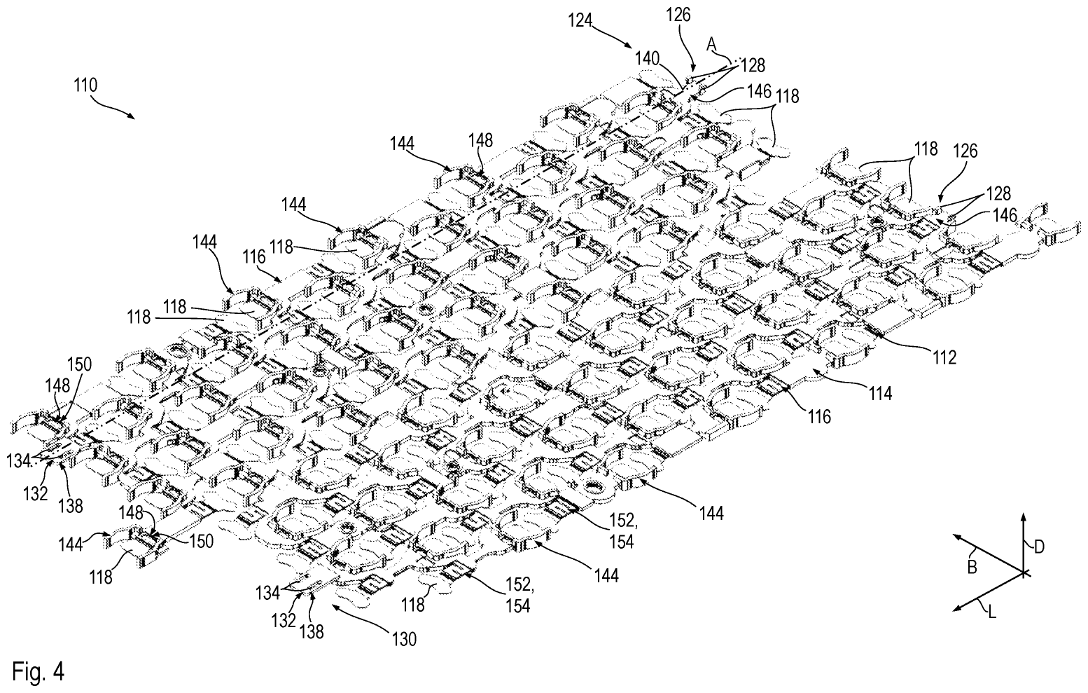

FIG. 4 illustrates a perspective view of a second embodiment according to the invention of a busbar interconnect of the present application,

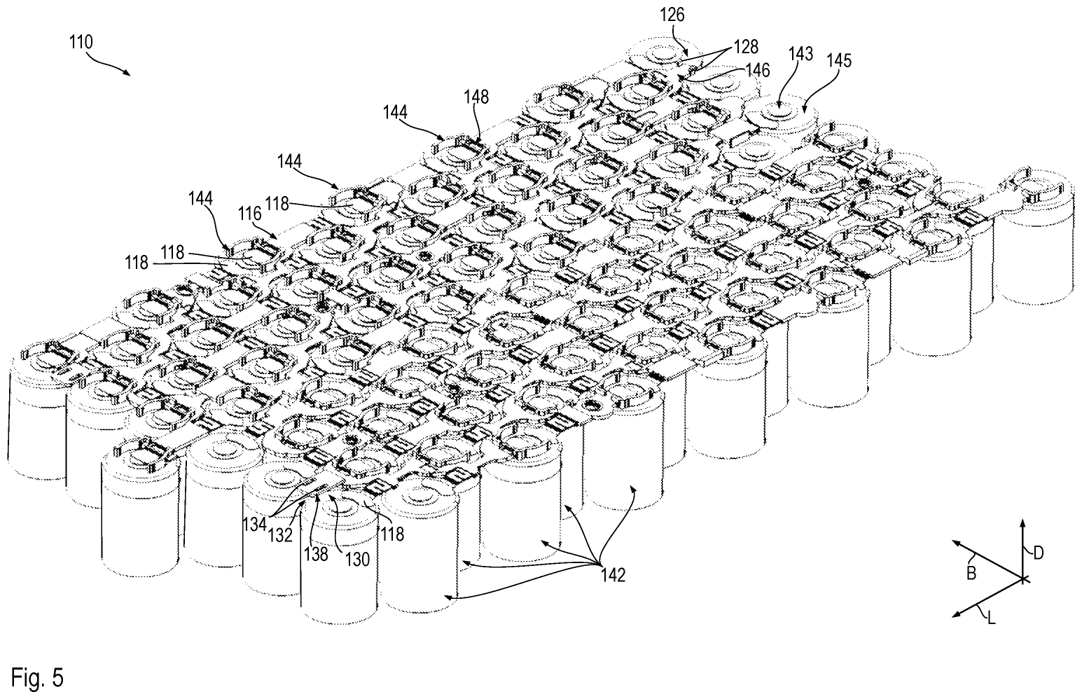

FIG. 5 shows a perspective view of the second embodiment according to the invention of the busbar interconnect of the present application with battery cells connected thereto, and

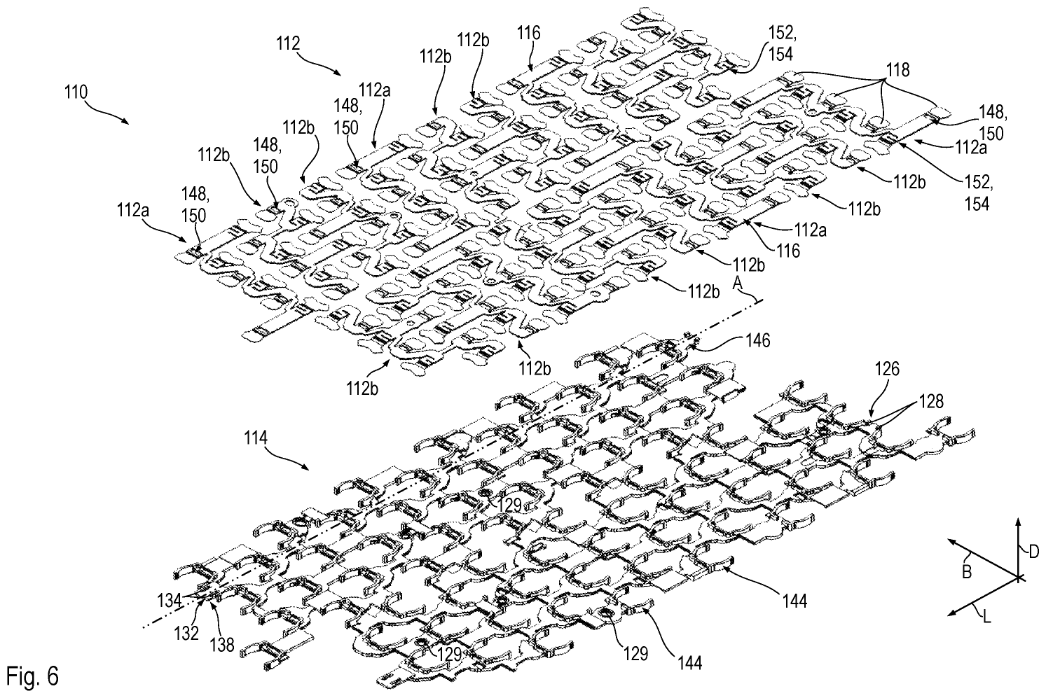

FIG. 6 shows a perspective exploded view of the busbar interconnect of the second embodiment from FIGS. 4 and 5.

In FIG. 1, a first embodiment of a modular busbar interconnect is designated generally by 10. The busbar interconnect 10 is illustrated in a perspective exploded view in FIG. 3.

The modular busbar interconnect 10 comprises an electrically conductive web structure 12 composed of aluminium, which is sectionally surrounded by a covering structure 14 composed of thermoplastic. In this case, the covering structure 14 is injection-moulded onto the web structure 12 by an injection-moulding method.

The web structure 12 and thus the busbar interconnect 10 have contact conductor sections 16, at the longitudinal ends of which exposed contact prongs 18, i.e. contact prongs omitted from the covering structure 14, are embodied, which contact prongs are embodied for contacting electrical terminals of battery cells. In this case, unslotted contact prongs 18 are embodied for connection to one type of terminal, positive or negative, of a battery cell and slotted contact prongs 18 are embodied for connection to the respective other type of terminal, negative or positive, of a battery cell.

The contact conductor sections 16 run not only next to one another but substantially parallel to one another and are electrically conductively connected to one another by connection conduction sections 20.

FIG. 1 illustrates a virtual parallelepiped 22 enveloping the busbar interconnect 10, said parallelepiped indicating that the busbar interconnect 10 is a planar component whose dimension in the longitudinal direction L is greater than in the width direction B orthogonal to the longitudinal direction L, and is considerably greater than in the thickness direction D orthogonal both to the longitudinal direction L and to the width direction B. A principal plane of extent of the busbar interconnect 10 is thus spanned by the longitudinal direction L and by the width direction B.

The busbar interconnect 10 is embodied for connection to further connection objects, the further connection objects preferably being busbar interconnects 10 of identical type. For this purpose, the busbar interconnect 10 has a first coupling region 24, in which two first coupling formations 26 in the form of in each case two latching projections 28 project from the covering structure 14 transversely with respect to the principal plane of extent, preferably orthogonally with respect to the principal plane of extent.

Along a virtual distance axis A, the virtual distance axis A running parallel to the longitudinal direction L in the exemplary embodiment illustrated, the busbar interconnect 10 has a second coupling region 30, in which two second coupling formations 32 in the form of in each case two latching cutouts 34 are embodied. In this case, a latching projection 28 of a first coupling region 24 of another busbar interconnect or of some other connection object can lead through and engage behind each latching cutout 34 in latching fashion.

By virtue of the latching connection that is producible between the latching projections 28 of one busbar interconnect 10 and the latching cutouts 34 of another busbar interconnect 10, the two busbar interconnects 10 can be coupled to one another in a positively locking manner, such that these can also be transported or relocated in a manner coupled to one another.

FIG. 2 shows two parallel arrangements with in each case two busbar interconnects coupled to one another in the manner described. The busbar interconnects lying next to one another in the width direction B lie next to one another without being connected in the embodiment illustrated.

In order to adjust the relative position of the two coupled busbar interconnects 10, the latching cutouts 34, along the virtual distance axis A, are embodied with a larger dimension than the latching projections 28 leading through them, such that the coupled busbar interconnects 10 are displaceable along a first tolerance compensation direction T1 (see FIG. 2), which is parallel to the virtual distance axis A, relative to one another by the absolute value of the difference between the dimensions of the latching projections 28 and the latching cutouts 34 along the virtual distance axis A.

Transversely with respect to the virtual distance axis A as well, i.e. along the width direction B in the exemplary embodiment illustrated, the latching cutouts 34 can have a larger dimension than the sections of the latching projections 28 that lead through them in the coupling state, such that there is a certain movement clearance between coupled busbar interconnects 10 also along a second tolerance compensation direction T2 (see FIG. 2), which is orthogonal to the virtual distance axis A and parallel to the principal plane of extent, which movement clearance allows a relative adjustment of the coupled busbar interconnect 10 transversely with respect to the virtual distance axis A.

In this way, a desired number of busbar interconnects 10 can be coupled to one another in a positively locking manner, in which case possible differences in dimensions caused by manufacturing tolerances that are manifested can be compensated for by the movement clearance in the coupling between latching cutouts 34 and latching projections 28. It is thus possible to ensure that the contact prongs 18 even of a plurality of busbar interconnects 10 coupled to one another lie at locations at which a battery terminal to be contacted in each case is situated.

Since the battery terminals of the battery cells, at least like battery terminals of the battery cells, are placed in a common plane parallel to the principal plane of extent of the busbar interconnect, the contact prongs 18 assigned in each case to like battery terminals are placed in a common plane in the exemplary embodiment illustrated. In the present example, this means that all unslotted contact prongs 18 lie in a common plane, and that all slotted contact prongs 18 lie in a common plane. Each of the planes is then an arrangement plane, each of which is preferably oriented parallel to the lower surface of the parallelepiped 22. The situation in which all the contact prongs 18 lie in a common plane is not precluded. Said common plane is the arrangement plane 36 of the contact prongs 18 and is represented by the lower surface of the parallelepiped 22.

The first and second contact formations 26 and 32, respectively, are preferably embodied at the covering structure 14 since the latter is produced by primary forming in an injection-moulding method and thus enables a particularly free configuration of the contact formations.

In the first exemplary embodiment, the latching projections 28 protrude from a section of the covering structure 14 that surrounds a contact conductor section 16 of the web structure 12. The cutouts 34 or the second coupling formations 32 are embodied at lugs 38 of the covering structure 14, which are formed exclusively from thermoplastic of the covering structure 14 and do not surround any electrical conductor. In this case, the lugs 38 are placed onto the surface 40 of a section of the covering structure 14 from which the latching projections 28 project, such that the electrically conductive web structures 12 of two coupled busbar interconnects 10 can lie in a common arrangement plane and such that primarily the contact prongs 18 of the coupled busbar interconnect can lie in a common arrangement plane 36.

For the sake of better clarity, only some components and component sections are provided with reference signs in FIG. 2. The upper arrangement of two coupled busbar interconnects 10 in FIG. 2 corresponds to the lower arrangement of two coupled busbar interconnects 10. However, it is arranged in a manner rotated by 180° in relation to an axis of rotation that is orthogonal to the arrangement plane of the contact prongs 18, i.e. that runs in the thickness direction D.

The passage openings 21 and 23 in the web structure 12 (see FIG. 3) serve for fixing the web structure 12 in the injection mould for injection moulding the covering structure 14 over or around said web structure. Since mountings lead through the passage openings 21 and 23 in the web structure 12 while the latter is accommodated in the injection mould, the covering structure 14 also has openings 25 and 27 aligned with the passage openings 21 and 23, respectively, of the web structure 12. An additional opening 29 in the covering structure 14 is predicated on a mounting pin in the injection mould that bears at the end face on the surface of a contact conductor section 16 in order to prevent a deformation of the contact conductor section 16 during the encapsulation of the web structure 12 with the covering structure 14 by injection moulding.

The web structure 12 and the covering structure 14 are each embodied integrally.

A second embodiment of a busbar interconnect according to the invention is shown and designated generally by 110 in FIG. 4. Components or component sections identical and functionally identical to those in the first embodiment are designated by the same reference signs in the second embodiment, but increased by the number 100. The second embodiment will otherwise be described only insofar as it differs from the first embodiment, to the description of which reference is otherwise made in its entirety for explaining the second embodiment as well.

The second embodiment of the busbar interconnect 110 comprises a significantly greater number of contact prongs 118 than the first embodiment. The contact prongs 118 are additionally configured with a larger contact area.

FIG. 5 shows the same embodiment of the busbar interconnect 110 with a plurality of battery cells 142, the terminals 143 and 145 of which are contacted by contact prongs 118. Preferably, the contact prongs 118 are connected to the terminals of the battery cells 142 cohesively, for example by means of laser welding.

A first differentiating feature besides the number and shape of contact prongs 118 resides in the roughly C-shaped distance ensuring sections 144, each of which surrounds a contact prong 118 over more than 180°. The distance ensuring sections 144 have a larger dimension in the thickness direction D than the other sections of the busbar interconnect 110. The distance ensuring sections 144 thus ensure a distance with respect to a surface of a battery housing placed over the busbar interconnect 110 and thus prevent undesired electrical effects, such as short circuits, for example, in the case of a deformation of the battery housing, for instance as a result of an accident of the vehicle carrying the respective battery.

As is discernible from FIG. 5, the distance ensuring sections 144 surround that battery terminal of a battery cell 142 which is contacted by the contact prong 118 that is likewise partly surrounded by them. The distance ensuring sections 144 are shaped as sections of the covering structure 114 by injection moulding. In FIG. 5, one positive battery terminal is provided with reference sign 143 in a manner representative of the other like battery terminals of the further battery cells 142. A negative battery terminal surrounding the positive battery terminal 143 concentrically is provided with reference sign 145. The battery terminals 143 and 145 form respective contact formations of the battery cells 142.

A further distinguishing feature that differentiates the second embodiment from the first embodiment resides in the embodiment of the first coupling formation 126 likewise at a lug 146 that is free of electrically conductive material. In the second embodiment, too, the lug 138 carrying the second coupling formation 132 is arranged offset in the thickness direction D of the busbar interconnect 110, such that the contact prongs 118 of a plurality of busbar interconnects 110 coupled to one another can lie in a common arrangement plane.

A further differentiating feature is constituted by the fuse sections 148, each of which directly follows a distance ensuring section in the region of the contact conductor sections 116. Each fuse section 148 is embodied as a considerable alteration of the cross-section of a contact conductor section 116, in the present case by way of the stamping out of a rectangular passage hole 150, such that only two residual webs running in the longitudinal direction L and enclosing the passage hole 150 have an electrically conductive effect in a fuse section 148. The fuse sections 148 are not surrounded by the covering structure 114, but rather are exposed, such that they can be visually inspected.

Furthermore, during the encapsulation of the web structure 112 with the covering structure 114 by injection moulding, the passage holes 150 of the fuse sections 148 can serve for securing and fixing the web structure 112 in the injection mould, as is done by means of the openings 21 and 23 of the web structure 12 in the first embodiment.

The web structure 112 is preferably formed from aluminium. In this case, the fuse sections 148 act as fusible link sections. In the case of an excessively high current flowing through, the residual webs enclosing the passage hole 150 of a fuse section 148 melt and thus interrupt the current flow.

Moreover, the web structure 112 of the second embodiment, more precisely the contact conductor sections 116, has spring sections 152, in which the material of the web structure 112 is slotted and therefore offers a lower deformation resistance to an external force than adjacent solid regions of the contact conductor sections 116. In the exemplary embodiment illustrated, the spring sections 152 are embodied as meandering structures 154 in the contact conductor sections 116. The spring sections 152 serve for further compensation of differences in dimensions, for example on account of manufacturing tolerances that are manifested.

If contact conductor sections 116 each have a contact prong 118 at each longitudinal end in a manner embodied integrally, a fuse section 148 is embodied in one longitudinal end region and a spring section 152 is embodied in the respective opposite longitudinal end region.

In both embodiments, the contact conductor sections 16 and 116 run rectilinearly and parallel to the virtual distance axis A.

The perspective exploded view in FIG. 6 illustrates in a particularly noticeable way the fact that the one integral covering structure 114 has a plurality of partial web structures 112a and 112b which are each integral but embodied physically separately from one another and which jointly form the web structure 112 of the busbar interconnect 110 of the second embodiment.

In this case, the web structure 112 comprises two series of partial web structures which are parallel to one another and to the virtual distance axis A and which are embodied substantially identically but arranged in a manner rotated by 180° with respect to one another in relation to an axis of rotation running in the thickness direction D. In each series of partial web structures 112a and 112b, there is arranged firstly a partial web structure 112a followed along the virtual distance axis A by two partial web structures 112b, which are embodied identically but once again arranged in a manner rotated by 180° with respect to one another in relation to an axis of rotation running in the thickness direction D. The partial web structures 112a and 112b connect battery cells 142 in each case electrically in parallel with one another. The parallel-connected battery cell arrangements of the respective partial web structures 112a and 112b are connected in series with one another. Two busbar interconnects 12 or else 112 that are coupled to one another electrically connect in series the battery cells 142 that are respectively contacted by them.

With the busbar interconnects presented in the present case, vehicle batteries of any desired size can be reliably configured in modular fashion.

1. Busbar interconnect for electrically conductively connecting battery cells, comprising a plurality of exposed contact prongs, each of which is embodied for cohesive connection to a contact formation of a battery cell, the contact prongs being embodied integrally with an electrically conductive web structure, the web structure electrically conductively connecting the contact prongs, a covering structure composed of electrically insulating material being arranged at at least one section of the web structure,
wherein the busbar interconnect has a first coupling region with at least one first coupling formation and has a second coupling region with at least one second coupling formation, said second coupling region being arranged at a distance from the first coupling region along a virtual distance axis, the first coupling formation and the second coupling formation being embodied complementarily such that the second coupling formation of the busbar interconnect is couplable to a first mating coupling formation of a first connection object different from the busbar interconnect, the first mating coupling formation corresponding to the first coupling formation in terms of its shape and its dimensions, and that the first coupling formation of the busbar interconnect is couplable to a second mating coupling formation of a second connection object different from the busbar interconnect, the second mating coupling formation corresponding to the second coupling formation in terms of its shape and its dimensions.

2. Busbar interconnect according to claim 1,
wherein one formation from the first and second coupling formations has a projection and in that the respective other formation from the first and second coupling formations has a cutout, the cutout having a clear width which has a larger dimension than the projection in at least one direction as a tolerance compensation direction.

3. Busbar interconnect according to claim 2,
wherein the tolerance compensation direction runs along the virtual distance axis or/and orthogonally with respect thereto.

4. Busbar interconnect according to claim 2,
wherein a plurality of the contact prongs are placed in a common arrangement plane, the tolerance compensation direction lying parallel to this arrangement plane.

5. Busbar interconnect according to claim 4,
wherein the at least one first coupling formation is embodied at a first connection lug running along the arrangement plane, and in that the at least one second coupling formation is embodied at a second connection lug running along the arrangement plane, the first connection lug and the second connection lug being arranged offset relative to one another transversely with respect to the arrangement plane.

6. Busbar interconnect according to claim 1,
wherein at least one of the at least one first coupling formation or/and at least one of the at least one second coupling formation is/are embodied at the covering structure.

7. Busbar interconnect according to claim 1,
wherein the electrically conductive web structure, between two contact prongs, has at least one fuse section embodied integrally with the web structure, the web structure having a smaller conduction cross-section in the fuse section than in the regions between the fuse section and each of the two contact prongs, at least one part of the fuse section being exposed without being covered by the covering structure.

8. Busbar interconnect according to claim 7,
wherein the fuse section, in a conductor section of the web structure connecting the two contact prongs along a connection path, is formed by a constriction narrowing the conductor section orthogonally with respect to the connection path or/and by a passage opening leading through the conductor section.

9. Busbar interconnect according to claim 1,
wherein a plurality of the contact prongs are placed in a common arrangement plane, at least one distance ensuring section being embodied at the covering structure of the busbar interconnect, said at least one distance ensuring section, orthogonally with respect to the arrangement plane, having a larger thickness dimension than sections of the covering structure adjacent to the distance ensuring sections.

10. Busbar interconnect according to claim 9,
wherein the at least one distance ensuring section is the region in which the busbar interconnect has the largest thickness dimension to be measured orthogonally with respect to the arrangement plane.

11. Busbar interconnect according to claim 9,
wherein the at least one distance ensuring section at least sectionally surrounds a contact prong.

12. Busbar interconnect according to claim 11,
wherein the contact prong is embodied as a longitudinal end of a conductor section of the web structure, the distance ensuring section only partly surrounding the contact prong and being interrupted in a region imagined to be lengthened along the course direction of the conductor section or/and in a region imagined to be lengthened along the virtual distance axis beyond the contact prong.

13. Busbar interconnect according to claim 1,
wherein the busbar interconnect has a plurality of contact conductor sections running next to one another, a contact prong being embodied at at least one longitudinal end of a contact conductor section, contact conductor sections running directly next to one another being electrically conductively connected to one another by a connection conductor section running between the contact conductor sections.

14. Busbar interconnect according to claim 13,
wherein the contact conductor sections each have a contact prong at each of their longitudinal ends.

15. Busbar interconnect according to claim 13,
wherein the contact conductor sections are arranged offset with respect to one another along their course direction.
